(19) United States
(12) Patent Application Publication
(10) Pub. No.: US 2012/0318888 A1
(43) Pub. Date: Dec. 20, 2012

(54) SPRINKLER WITH REPELLING MAGNETS

(75) Inventor: Vitaly GANDIN, Kiryat Shmona (IL)

(73) Assignee: NAANDAN JAIN IRRIGATION C.S. LTD., Kibbutz Naan (IL)

(21) Appl. No.: 13/476,434

(22) Filed: May 21, 2012

Related U.S. Application Data
(60) Provisional application No. 61/498,715, filed on Jun. 20, 2011.

(51) Int. Cl. B05B 3/04

(52) U.S. Cl. 239/222.17

(57) ABSTRACT

A sprinkler including a first portion arranged to lie along a generally vertical axis, a second portion arranged to rotate about the generally vertical axis relative to the first portion and to be displaced along the generally vertical axis responsive to impingement of a water stream thereon, at least a first magnet associated with the first portion and at least a second magnet associated with the second portion, the first and second magnets being magnetized to repel each other at least generally along the generally vertical axis.

### REFERENCE TO RELATED APPLICATIONS

Reference is made to U.S. Provisional Patent Application Ser. No. 61/498,715, filed Jun. 20, 2011 and entitled “SPRINKLER WITH PROPELLING MAGENTS”, the disclosure of which is hereby incorporated by reference and priority of which is hereby claimed pursuant to 37 CFR 1.78(a) (4) and (5)(i).

### FIELD OF THE INVENTION

The present invention relates to sprinklers generally.

### BACKGROUND OF THE INVENTION

The following patent publications are believed to represent the current state of the art:

U.S. Pat. Nos. 6,016,972 & 7,111,796 and U.S. Published Patent Application No. 2007/009535.

### SUMMARY OF THE INVENTION

The present invention seeks to provide an improved sprinkler

There is thus provided in accordance with a preferred embodiment of the present invention a sprinkler including a first portion arranged to lie along a generally vertical axis, a second portion arranged to rotate about the generally vertical axis relative to the first portion and to be displaced along the generally vertical axis responsive to impingement of a water stream thereon, at least a first magnet associated with the first portion and at least a second magnet associated with the second portion, the first and second magnets being magnetized to repel each other at least generally along the generally vertical axis.

Preferably, the first portion is a fixed portion. Alternatively, the first portion is a non-fixed portion.

In accordance with a preferred embodiment of the present invention the first portion is a base portion.

In accordance with a preferred embodiment of the present invention the first and second magnets are operative to retain the second portion in an intermediate vertical position along the generally vertical axis relative to the first portion.

Preferably, the first portion includes a water inlet, a water passageway and a water outlet arranged to provide the water stream. Additionally, the water inlet, the water passageway and the water outlet are all arranged generally about the generally vertical axis.

In accordance with a preferred embodiment of the present invention the second portion includes a housing portion and a rotatable deflector arranged for common rotation about the generally vertical axis.

Preferably, the first magnet is fixed to the first portion.

In accordance with a preferred embodiment of the present invention the sprinkler also includes a slidable and rotatable bearing fixed to the second portion above the first and second magnets.

### BRIEF DESCRIPTION OF THE DRAWINGS

The present invention will be understood and appreciated from the following detailed description, taken in conjunction with the drawings in which:

FIGS. 1A & 1B are simplified exploded-view illustrations of a sprinkler constructed and operative in accordance with a preferred embodiment of the present invention in respective top-to-bottom and bottom-to-top views;

FIGS. 2A & 2B are simplified illustrations of an assembled sprinkler corresponding to the sprinkler of FIGS. 1A & 1B in respective top-to-bottom and bottom-to-top views;

FIGS. 3A and 3B are sectional illustrations taken along respective lines IIIA-IIIA and IIIB-IIIB in FIG. 2A;

FIGS. 4A, 4B, 4C and 4D are, respectively, top side view, bottom side view, bottom view and sectional view illustrations of a rotatable deflector, forming part of the sprinkler of FIGS. 1A-3B, FIG. 4C being taken in a direction IVC indicated in FIG. 4B and FIG. 4D being taken along lines IVD-IVD in FIG. 4A;

FIGS. 5A, 5B, 5C and 5D are, respectively, top view, bottom view and mutually perpendicular sectional view illustrations of a body portion, forming part of the sprinkler of FIGS. 1A-3B, FIGS. 5C and 5D being taken along respective lines VC-VC and VD-VD in FIG. 5A;

FIGS. 6A, 6B and 6C are, respectively, top view, bottom view and sectional view illustrations of a base portion, forming part of the sprinkler of FIGS. 1A-3B, FIG. 6C being taken along lines VIC-VIC in FIG. 6A;

FIGS. 7A and 7B are respective pictorial and top view illustrations of a bearing, forming part of the sprinkler of FIGS. 1A-3B;

FIGS. 8A and 8B are illustrations of the sprinkler of FIGS. 1A-3B coupled to a water supply line in respective pressurized and non-pressurized operative orientations;

FIGS. 9A and 9B are sectional illustrations of the sprinkler of FIGS. 1A-3B coupled to a water supply line in upward facing respective pressurized and non-pressurized operative orientations, taken along respective lines IXA-IXA and IXB-IXB in FIGS. 8A and 8B respectively;

FIGS. 10A and 10B are sectional illustrations of the sprinkler of FIGS. 1A-3B coupled to a water supply line in downward facing respective pressurized and non-pressurized operative orientations, taken along respective lines IXA-IXA and IXB-IXB in FIGS. 8A and 8B respectively, but in an upside-down orientation as compared with the orientation shown in FIGS. 8A and 8B;

FIG. 11 is a simplified exploded-view illustration of a sprinkler constructed and operative in accordance with a preferred embodiment of the present invention;

FIG. 12 is a simplified illustration of an assembled sprinkler corresponding to the sprinkler of FIG. 11; and

FIGS. 13A and 13B are sectional illustrations of the sprinkler of FIGS. 11 and 12 coupled to a water supply line in upward facing respective non-pressurized and pressurized operative orientations, taken along lines XIII-XIII in FIG. 12.

### DETAILED DESCRIPTION OF A PREFERRED EMBODIMENT

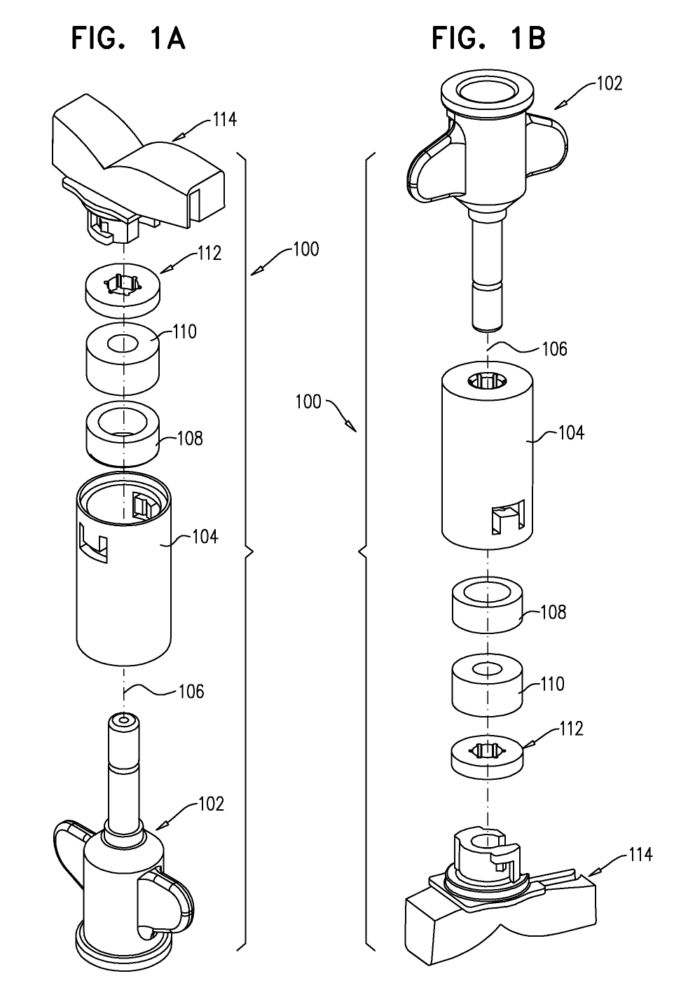

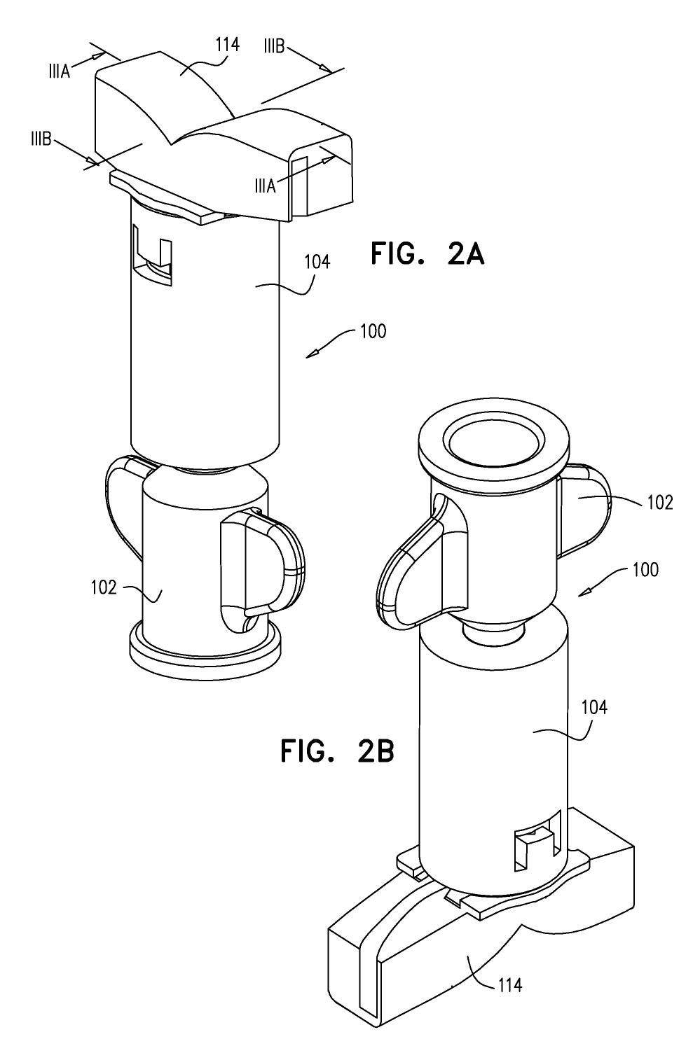

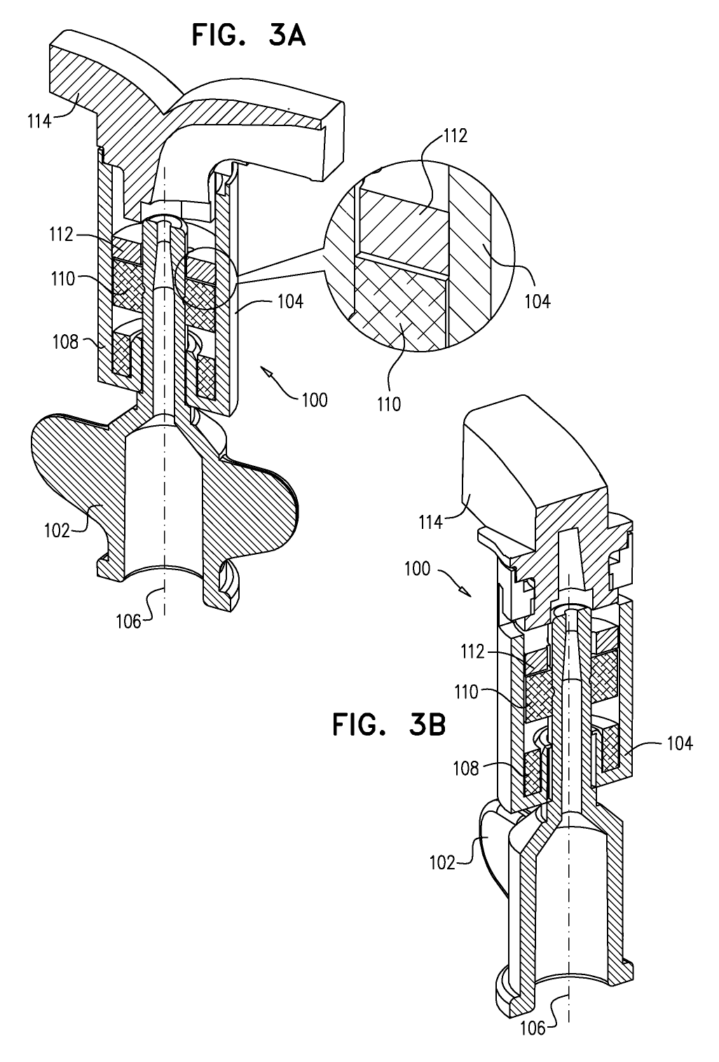

Reference is now made to FIGS. 1A & 1B, which are simplified exploded-view illustrations of a sprinkler, constructed and operative in accordance with a preferred embodiment of the present invention, in respective top-to-bottom and bottom-to-top views, to FIGS. 2A & 2B, which are simplified illustrations of an assembled sprinkler, corresponding to the sprinkler of FIGS. 1A & 1B, in respective top-to-bottom and bottom-to-top views, and to FIGS. 3A and 3B, which are sectional illustrations taken along respective lines IIIA-IIIA and IIIB-IIIB in FIG. 2A.

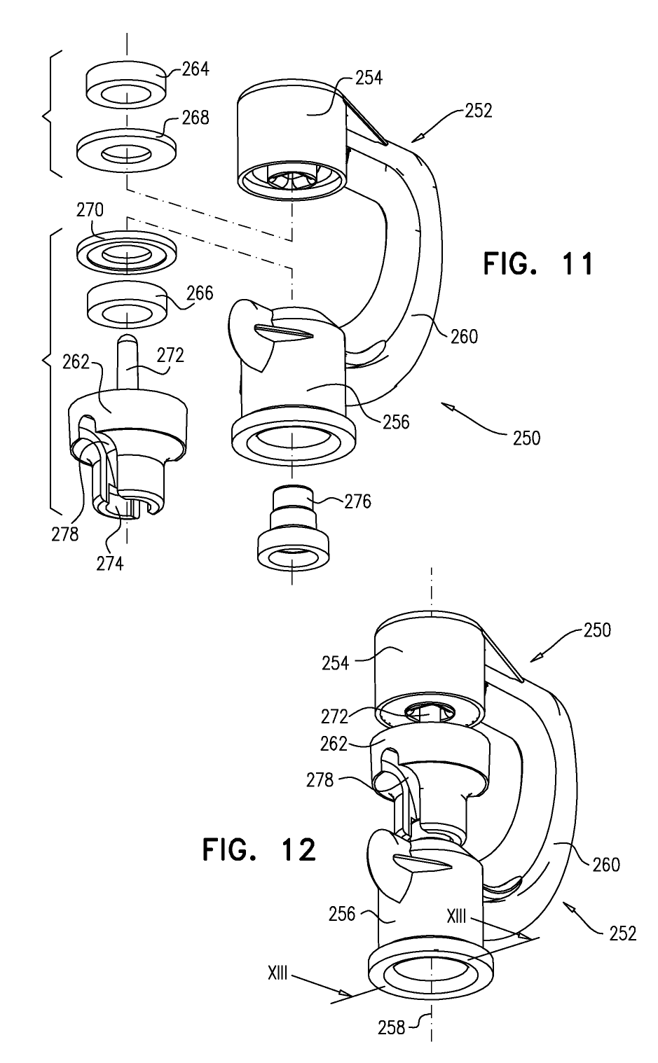

It is appreciated that the description of FIGS. 1A-9B which follows relates to a sprinkler in an upstanding orientation as shown in FIGS. 1A-9B and structural terms, such as “top”, “bottom”, “upper” and “lower”, which are incorporated in the descriptors of elements of the sprinkler and directional terms such as “raise” and “lower”, which are used to describe axial displacements of parts of the sprinkler are to be understood in this context. As shown, for example in FIGS. 10A & 10B, the sprinkler of FIGS. 1A-9B, or a sprinkler similar thereto in relevant respects, can also be employed in an opposite, upside-down orientation. For the sake of clarity, the description of FIGS. 10A & 10B employs the same structural terms as used in the description of FIGS. 1A-9B, for identical or similar elements of the sprinkler, notwithstanding the opposite directional orientation of the sprinkler as shown in FIGS. 10A & 10B, but employs opposite directional terms, such as “raise” and “lower”, to describe axial displacements of parts of the sprinkler.

As seen in FIGS. 1A-3B, there is provided a sprinkler 100 including a base portion 102 and a body portion 104. Base portion 102 defines a vertical axis 106. Body portion 104 is vertically raisable with respect to the base portion 102 along axis 106, when the sprinkler is pressurized. Mounted on body portion 104 is a cylindrical magnet 108. Fixedly mounted on base portion 102 and spaced from magnet 108 is a cylindrical magnet 110, which is magnetized oppositely to magnet 108 such that magnets 108 and 110 mutually repel along axis 106. A bearing 112 is fixedly mounted onto body portion 104 and is arranged for slidable and rotatable motion relative to base portion 102 respectively along and about axis 106.

A rotatable deflector 114 is fixedly mounted onto body portion 104 for slidable and rotatable motion together with body portion 104 relative to base portion 102 respectively along and about axis 106.

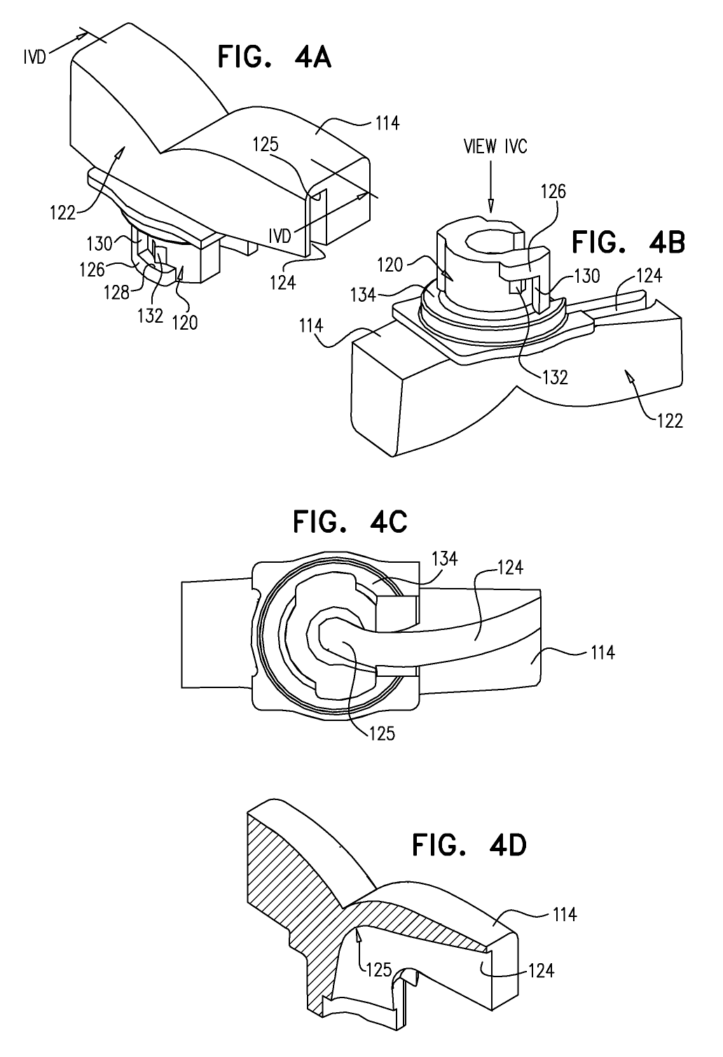

Reference is now made to FIGS. 4A, 4B, 4C and 4D, which are, respectively, top side view, bottom side view, bottom view and sectional view illustrations of rotatable deflector 114, forming part of the sprinkler of FIGS. 1A-3B, FIG. 4C being taken in a direction IVC indicated in FIG. 4B and FIG. 4D being taken along lines IVD-IVD in FIG. 4A.

As seen in FIGS. 4A-4C, rotatable deflector 114 comprises a base portion 120, which is configured for being removably connected to body portion 104 in a bayonet connection, and an upper portion 122, integrally formed with base portion 120. A three-dimensionally curved water flow deflection pathway 124 is defined by base portion 120 and upper portion 122 and extends from a central region of base portion 120 upwardly and radially outwardly along an underside of one side of upper portion 122. Water flow deflection pathway 124 includes an upper water stream impingement surface 125.

Base portion 120 is preferably formed with a pair of mutually circumferentially spaced, oppositely facing, radially outwardly extending L-shaped protrusions 126, including a slightly inclined generally horizontal leg 128 and a vertical leg 130. A narrow tooth 132 extends radially upward from generally horizontal leg 128, preferably to a radial extent less than that of the L-shaped protrusions 126. Base portion 120 preferably also has a circumferential abutment surface 134.

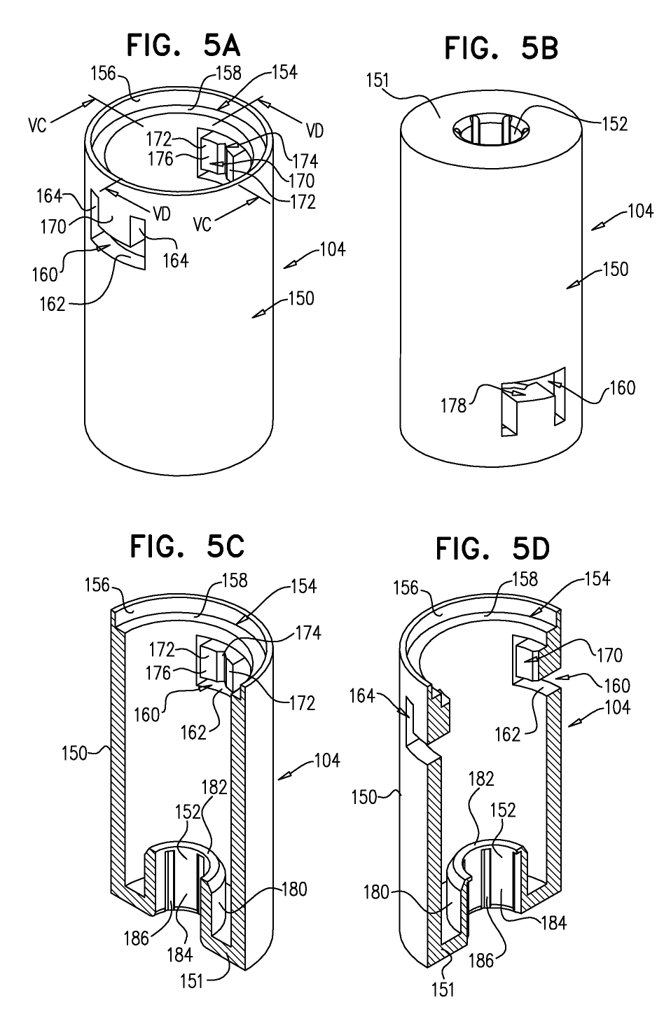

Reference is now made to FIGS. 5A, 5B, 5C and 5D, which are, respectively, top view, bottom view and mutually perpendicular sectional view illustrations of body portion 104, forming part of the sprinkler of FIGS. 1A-3B, FIGS. 5C and 5D being taken along respective lines VC-VC and VD-VD in FIG. 5A.

As seen in FIGS. 5A-5D, body portion 104 is generally circularly cylindrical and includes a generally cylindrical outer wall portion 150, an annular bottom wall portion 151 and a generally cylindrical internal bottom hub portion 152. Generally cylindrical outer wall portion 150 is formed with a circumferential upper facing inner recess 154 having an inner facing circumferential recess wall 156 and an upper facing circumferential inner wall portion 158.

Generally cylindrical outer wall portion 150 is formed with a pair of circumferentially spaced, mutually oppositely facing U-shaped cut outs 160, each having a generally horizontal base 162 and a pair of upstanding sides 164.

Disposed above base 162 and between upstanding sides 164 of each of cut outs 160 is an inner facing bifurcated protrusion 170. Inner facing bifurcated protrusion 170 includes a pair of protrusion portions 172 arranged side by side and separated by a generally V-shaped groove 174. Protrusions 172 each define an inclined inwardly facing surface 176, which is inclined towards groove 174, and an inclined downwardly facing surface 178.

It is appreciated that the bayonet connection between the rotatable deflector 114 and the body portion 104 is effected by engagement of teeth 132 of rotatable deflector 114 with grooves 174 when generally horizontal legs 128 of L-shaped protrusions 126 engage corresponding generally inclined surfaces 178 of protrusions 172, providing tight engagement between upper facing circumferential inner wall portion 158 of body portion 104 and circumferential abutment surface 134 of rotatable deflector 114.

Generally cylindrical internal bottom hub portion 152 preferably has a cylindrical outer facing surface 180, terminating in a circumferential surface 182, and a generally cylindrical inner facing surface 184 having formed therewithin a plurality of mutually circumferentially spaced grooves 186. Generally cylindrical inner facing surface 184 serves as a bearing surface permitting relatively low friction rotation of body portion 104 about base portion 102.

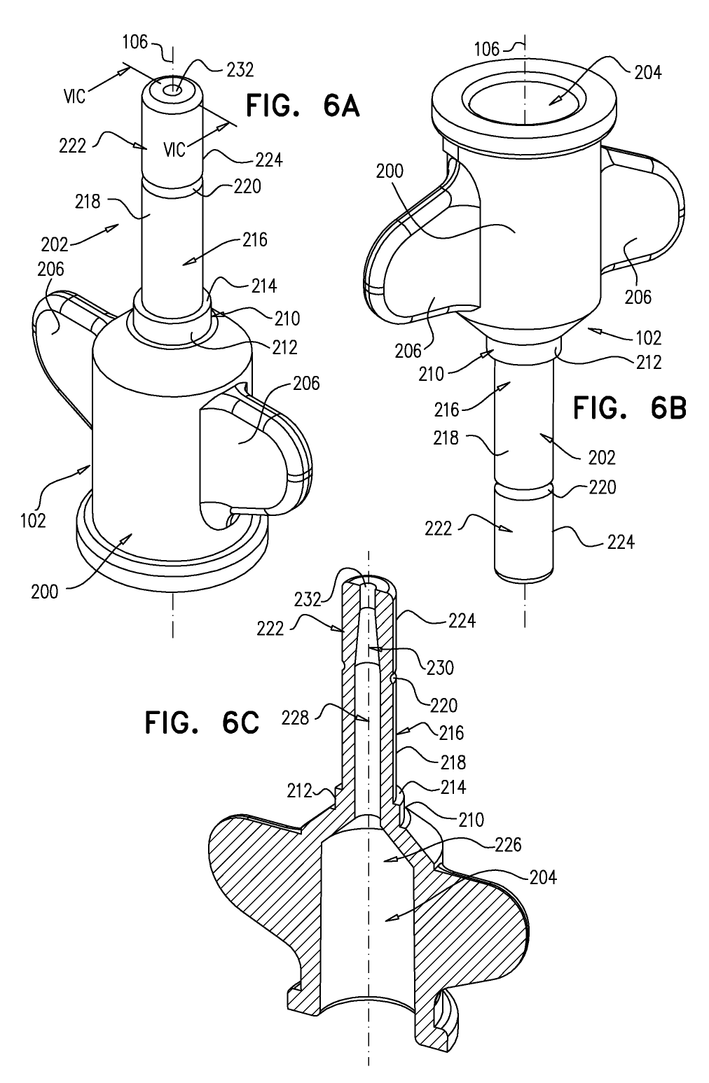

Reference is now made to FIGS. 6A, 6B and 6C, which are, respectively, top view, bottom view and sectional view illustrations of base portion 102, forming part of the sprinkler of FIGS. 1A-3B, FIG. 6C being taken along lines VIC-VIC in FIG. 6A.

As seen in FIGS. 6A-6C, base portion 102 comprises a generally cylindrical element, preferably arranged about a generally vertical axis 106 (FIG. 1) and having a generally circularly cylindrical lower portion 200 and a generally cylindrical upper portion 202, integrally formed therewith.

Generally circularly cylindrical lower portion 200 is preferably formed with a slightly tapered bore portion 204, which is adapted for conventional taper lock engagement with a water outlet and is formed with a pair of radially extending wings 206 to facilitate manual engagement and disengagement thereof from the water outlet.

Generally cylindrical upper portion 202 preferably includes a first intermediate cylindrical portion 210 having a generally cylindrical outer surface 212 and a circumferential top surface 214. Disposed above first intermediate cylindrical portion 210 is a second intermediate cylindrical portion 216, having a generally cylindrical outer surface 218 and whose outer diameter is less than that of first intermediate cylindrical portion 210. Second intermediate cylindrical portion 216 terminates upwardly at a circumferential groove 220.

Extending upwardly along axis 106 from circumferential groove 220 is a top cylindrical portion 222, having a generally cylindrical outer surface 224.

An upwardly directed pressurized water flow path is defined by bore portion 204, above which is formed a more highly tapered bore portion 226, which communicates with a bore portion 228, traversing first and second intermediate cylindrical portions 210 and 216. Bore portion 228 communicates with a tapered bore portion 230, which traverses top cylindrical portion 222 and terminates in a top bore portion 232.

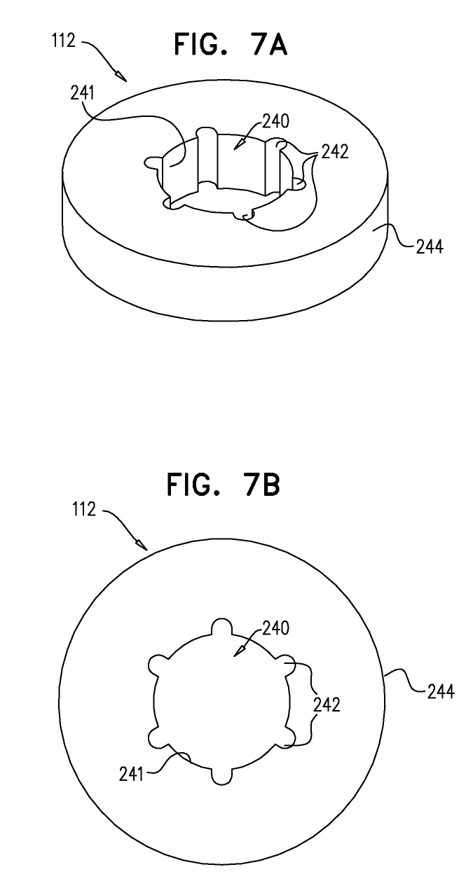

Reference is now made to FIGS. 7A and 7B, which are respective pictorial and top view illustrations of bearing 112, forming part of the sprinkler of FIGS. 1A-3B. As seen in FIGS. 7A & 7B, bearing 112 has a generally disc-like configuration having a central inner aperture 240. Central inner aperture 240 defines an inner generally circular bearing surface 241 and has circumferentially separated, radially extending recesses 242. Bearing 112 also has a generally circular outer circumferential surface 244.

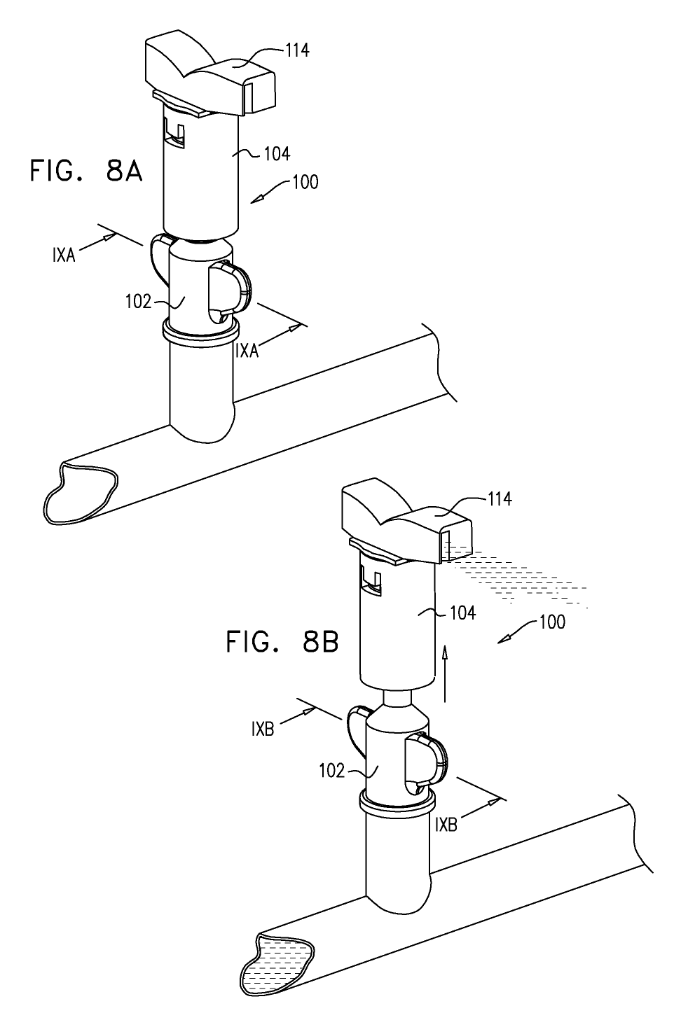

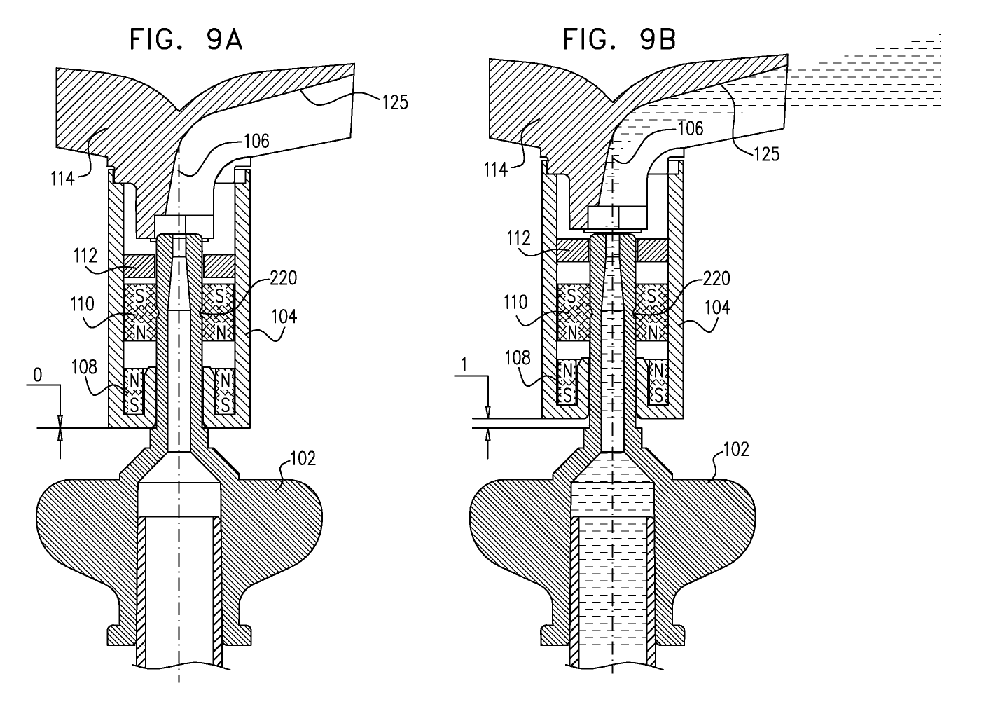

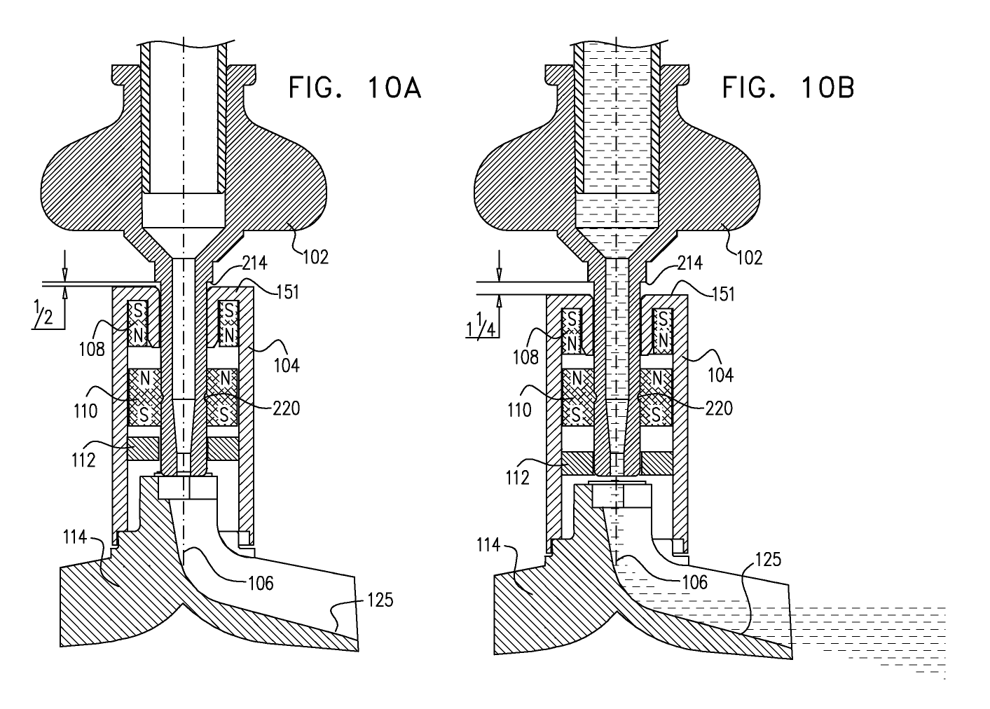

Reference is now made to FIGS. 8A and 8B, which are illustrations of the sprinkler of FIGS. 1A-3B coupled to a water supply line in respective non-pressurized and pressurized operative orientations, and to FIGS. 9A and 9B, which are sectional illustrations of the sprinkler of FIGS. 1A-3B coupled to a water supply line in upward facing respective non-pressurized and pressurized operative orientations, taken along respective lines IXA-IXA and IXB-IXB in FIGS. 8A and 8B, respectively.

As seen from a comparison of FIGS. 8A & 9A with FIGS. 8B & 9B, supply of water under pressure through the water path defined by bore portions 204, 226, 228, 230 and 232 causes a stream of water to impinge upwardly on upper water stream impingement surface 125 of rotatable deflector 114, thereby displacing rotatable deflector 114, and body portion 104, which is coupled thereto, upwardly along axis 106.

It is noted that magnet 110 is retained at a given height along axis 106 by physical engagement with circumferential groove 220 in base portion 102. Upward displacement of body portion 104 brings magnet 108, which is fixed therein, closer to magnet 110, which increases the repulsion force therebetween and urges the body portion against the upward displacement. This results in a dynamic equilibrium between the forces exerted by the water flow and the magnetic repulsion, with the result that the body portion 104 floats relative to the base portion 102 and minimizes frictional engagement therewith.

Reference is now made to FIGS. 10A and 10B, which are sectional illustrations of the sprinkler of FIGS. 1A-3B coupled to a water supply line in downward facing respective pressurized and non-pressurized operative orientations, taken along respective lines IXA-IXA and IXB-IXB in FIGS. 8A and 8B respectively, but in an upside-down orientation as compared with that shown in FIGS. 8A and 8B, which orientation is particularly suitable for use in greenhouses.

As seen from a comparison of FIGS. 10A and 10B, supply of water under pressure through the water path defined by bore portions 204, 226, 228, 230 and 232 causes a stream of water to impinge on water stream impingement surface 125 of rotatable deflector 114, thereby displacing rotatable deflector 114, and body portion 104, which is coupled thereto, downwardly along axis 106.

It is noted that magnet 110 is retained at a given height along axis 106 by physical engagement with circumferential groove 220 in base portion 102. Downward displacement of body portion 104 brings magnet 108, which is fixed therein, closer to magnet 110, which increases the repulsion force therebetween and urges the body portion against the downward displacement. This results in a dynamic equilibrium between the forces exerted by the water flow and the magnetic repulsion, with the result that the body portion 104 floats relative to the base portion 102 and minimizes frictional engagement therewith.

It is noted that in the operative orientation of FIGS. 10A and 10B, when the sprinkler is in a non-pressurized state, shown in FIG. 10A, a separation, here arbitrarily designated as “½”, is shown between annular bottom wall portion 151 of body portion 104 and circumferential top surface 214 of base portion 102. Typically, when the sprinkler is in a pressurized state, as shown in FIG. 10B, the separation between annular bottom wall portion 151 of body portion 104 and circumferential top surface 214 of base portion 102 increases and thus is arbitrarily designated in FIG. 10B as “1¼”. It is appreciated that in actuality, no separation may exist between annular bottom wall portion 151 of body portion 104 and circumferential top surface 214 of base portion 102 in the non-pressurized state. It is also appreciated that when sprinkler 100 is particularly designed for use in the upside-down orientation shown in FIGS. 10A & 10B, the water stream impingement surface 125 of rotatable deflector 114 may be reconfigured accordingly to provide desired water distribution.

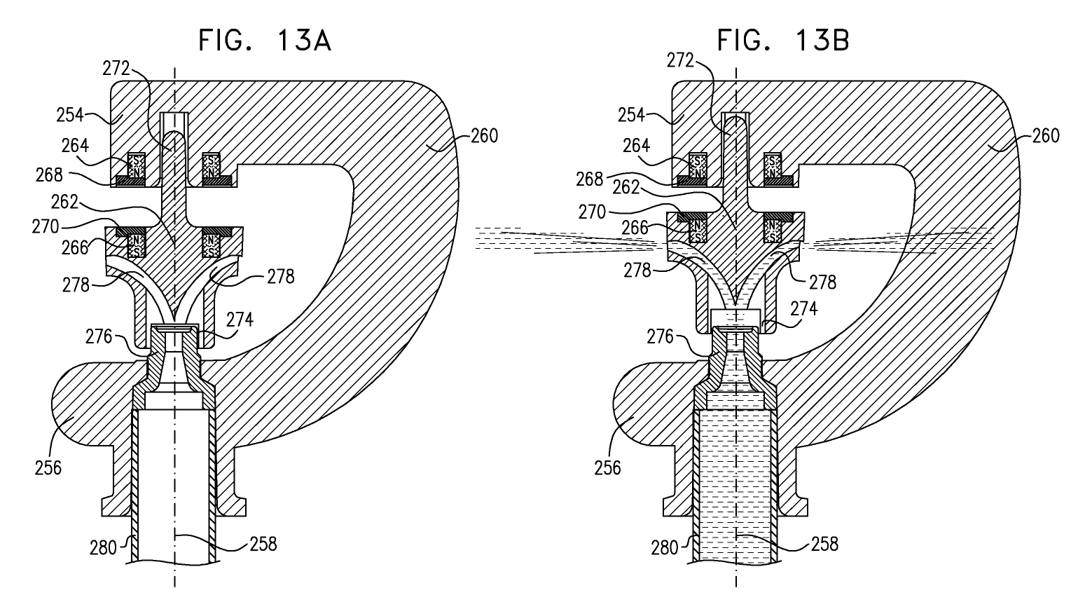

Reference is now made to FIGS. 11 and 12, which are simplified illustrations of a sprinkler 250 constructed and operative in accordance with a preferred embodiment of the present invention and to FIGS. 13A and 13B, which are sectional illustrations of sprinkler 250 of FIGS. 11 and 12 coupled to a water supply line in upward facing respective non-pressurized and pressurized operative orientations.

It is appreciated that the description of FIGS. 11-13B which follows relates to a sprinkler in an upstanding orientation, as shown in FIGS. 11-13B, and structural terms, such as “top”, “bottom”, “upper” and “lower”, which are incorporated in the descriptors of elements of the sprinkler, and directional terms, such as “raise” and “lower”, which are used to describe axial displacements of parts of the sprinkler, are to be understood in this context. Sprinkler 250 of FIGS. 11-13B, or a sprinkler similar thereto in relevant respects, can also be employed in an opposite, upside-down orientation.

As seen in FIGS. 11-13B, sprinkler 250 includes a body portion 252, having a top part 254 and a bottom part 256, aligned along a vertical axis 258 and joined by a side arm 260. A rotating deflector 262 is mounted between top part 254 and bottom part 256 for rotation relative thereto about vertical axis 258.

As seen clearly in FIGS. 13A & 13B, first and second, respectively oppositely magnetized magnets 264 and 266 are mounted, respectively, in recesses formed in top part 254 and rotating deflector 262 and are sealingly retained therein by respective sealing rings 268 and 270.

It is seen that rotating deflector 262 is formed with an upper shaft portion 272 which is rotatably seated in a corresponding socket in top part 254 and a generally cylindrical lower mounting portion 274 which is rotatably mounted about a nozzle element 276, which is seated in bottom part 256, as seen clearly in FIGS. 13A and 13B. Rotating deflector 262 preferably defines a pair of oppositely directed water directing pathways 278 which direct water vertically impinging thereon from nozzle element 276 upwardly and sideways in the sense of FIGS. 11-13B.

Reference is now made specifically to FIGS. 13A and 13B, which are sectional illustrations of the sprinkler of FIGS. 11 and 12 coupled to a water supply line in respective non-pressurized and pressurized operative orientations. As seen from a comparison of FIGS. 13A & 13B, supply of water under pressure through a water path defined by a water supply conduit 280 and nozzle element 276 along vertical axis 258 causes a stream of water to impinge upwardly on oppositely directed water directing pathways 278, thereby producing rotation of rotating deflector 262 and displacement of rotating deflector 262 upwardly along axis 258 relative to body portion 252.

It is noted that upward displacement of rotating deflector 262 brings magnet 266, which is fixed therein, closer to magnet 264, which increases the repulsion force therebetween and urges the rotating deflector 262 against the upward displacement. This results in a dynamic equilibrium between the forces exerted by the water flow and the magnetic repulsion with the result that the rotating deflector 262 floats relative to the body portion 252 and minimizes frictional engagement therewith.

It will be appreciated by persons skilled in the art that the present invention is not limited by what has been particularly shown and described hereinabove. Rather the scope of the present invention includes both combinations and subcombinations of the various features described hereinabove as well as modifications and variations thereof which are not in the prior art.

1. A sprinkler comprising:
a first portion arranged to lie along a generally vertical axis;
a second portion arranged to rotate about said generally vertical axis relative to said first portion and to be displaced along said generally vertical axis responsive to impingement of a water stream thereon;
at least a first magnet associated with said first portion; and
at least a second magnet associated with said second portion, said first and second magnets being magnetized to repel each other at least generally along said generally vertical axis.

2. A sprinkler according to claim 1 and wherein said first portion is a fixed portion.

3. A sprinkler according to claim 1 and wherein said first portion is a base portion.

4. A sprinkler according to claim 1 and wherein said first and second magnets are operative to retain said second portion in an intermediate vertical position along said generally vertical axis relative to said first portion.

5. A sprinkler according to claim 1 and wherein said first portion comprises a water inlet, a water passageway and a water outlet arranged to provide said water stream.

6. A sprinkler according to claim 5 and wherein said water inlet, said water passageway and said water outlet are all arranged generally about said generally vertical axis.

7. A sprinkler according to claim 1 and wherein said second portion includes a housing portion and a rotatable deflector arranged for common rotation about said generally vertical axis.

8. A sprinkler according to claim 1 and wherein said first magnet is fixed to said first portion.

9. A sprinkler according to claim 1 and also comprising a slidable and rotatable bearing fixed to said second portion above said first and second magnets.

10. A sprinkler according to claim 1 and wherein said first portion is a non-fixed portion.
